(19) United States
(12) Patent Application Publication
(10) Pub. No.: US 2006/0012175 A1
(43) Pub. Date: Jan. 19, 2006

(54) Trunking and coupling means therefor

(76) Inventor: Richard John Thompson, Wolsingham (GB)

Correspondence Address: Zilka-Kotab, PC, P.O. BOX 721120, SAN JOSE, CA, 95172-1120, US

(21) Appl. No.: 10/513,906

(22) PCT Filed: Apr. 22, 2003
(86) PCT No.: PCT/GB03/01708

§ 371 Date: Jun. 24, 2005

(30) Foreign Application Priority Data
May 17, 2002 (GB) 0211370.2

(51) Int. Cl. F16L 21/00

(52) U.S. Cl. 285/417

(57) ABSTRACT

A section of waterproof trunking (30) has an elongate tubular member (32) of rectangular cross section, two opposing sides of which have holes (34) with screws therein. These holes act as means for attaching member (32) to further members (32a) and/or (32b). Member (32) also has an aperture (36) in one side. Aperture (36) has a length L₁ which is substantially less than the length L₂ of member (32), this length being measured axially along member (32). Aperture (36) also has dimension L₃ which is measured perpendicular to L₁ and L₂, and this length is equal to or slightly less than length L₄, the external dimension of member (32) measured in the same direction. Trunking section (30) also has closure means (38) for the or each aperture (36). Closure means (38) has a cover plate (40) which is attached to member (32) by use of screws (42) through holes (43) and into threaded holes (44). Plate (40) is also provided with a neoprene sealing gasket (46).

The present invention relates to trunking and coupling means therefor, and particularly, not exclusively, to waterproof trunking for carrying electrical cables.

The carrying of electrical cables in a network of trunking is used in many industries. In the food, beverage and pharmaceutical industries, where hygiene is of paramount importance, stainless steel trunking is regularly used. It is important that such trunking is easily cleaned and that places where dirt may gather, and infestation:may occur, are kept to a minimum.

In some situations it is necessary to provide a waterproof trunking. For example, where trunking is located near a high ceiling the preferred method of cleaning maybe to direct a jet of water at the trunking from the ground. As a result, the term waterproof is used within this document to refer to the amount of sealing of joints that is required, between parts of the trunking, in order to prevent water penetrating under the circumstances of this type of cleaning.

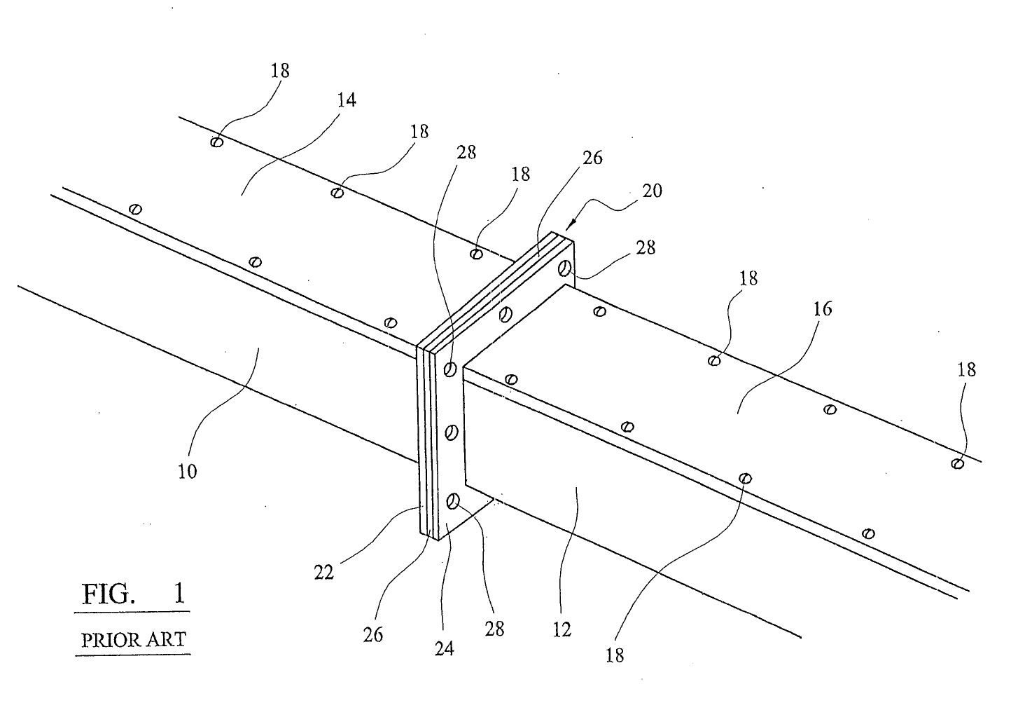

An example of a trunking system of this type is shown in FIG. 1. The trunking shown consists of elongated trunking members 10 and 12 having respective lids 14 and 16. Each lid is retained in position by screws 18 and the junction between members 10 and 12 and respective lids 14 and 16 is sealed with a gasket (not shown). In order to provide an adequate seal for the waterproofing required it is necessary to provide a large number of screws 18. If only a few screws 18 are used the lids 14 and 16 buckle along their edges, providing gaps which allow water inside the trunking members 10 and 12. As a result of the large number of screws used to provide this seal, the time taken to install this waterproof trunking is significant.

A coupling 20 is used to join trunking members 10 and 12. The coupling 20 consists of first coupling plate 22, attached to trunking member 10 and a second coupling plate 24 attached to trunking member 12. Between coupling plates 22 and 24 is a gasket seal 26. The coupling plates 22 and 24 are fixed together using screws in holes 28. This form of coupling creates a significant number of dirt traps around the edge of plates 22 and 24 and in holes 28. The gasket 26 is also exposed around all of the edge of plates 22 and 24, providing a further dirt trap.

Preferred embodiments of the present invention seek to overcome the above described disadvantages of the prior art.

According to an aspect of the present invention there is provided a section of waterproof trunking comprising:—
at least one elongate tubular member of substantially rectangular cross-section having attaching means for attaching the or each said member to at least one further member and having at least one aperture in at least one respective side of said member for providing access to the interior of, said member, wherein the or each said aperture has a length less than the length of the or each said side measured in an axial direction along said tubular member and has a dimension less than the dimension of said side measured transverse to said axial direction; and
respective closure means for the or each said aperture.

By having a trunking member with small apertures in at least one side and closure means therefor, provides the advantage that the majority of any trunking member is entirely sealed along its length at all times. Therefore, the only points at which potential leaks may be found are around the closures to the aperture and the joints between adjacent members and any couplings therebetween. The advantage is also provided that the number of securing screws is significantly reduced, thereby reducing the time required to install the trunking as well as reducing the number of potential dirt traps which require cleaning.

In a preferred embodiment the attaching means includes at least one hole in said member adapted to receive a respective screw or bolt for retaining the member in position relative to a further member.

In another preferred embodiment the attaching means is at least one threaded member extending internally from said member and adapted to engage a coupling internally of said member, said coupling having slots therein allowing said threaded members to pass along said slots.

By providing the member with internally located threaded engaging means and slots in the coupling, the advantage is provided that the trunking member is provided with even fewer holes on its external surface thereby reducing the number of dirt traps.

The closure means may comprise a plate adapted to cover said aperture.

In a preferred embodiment said plate is provided with a plurality of holes adapted to receive respective screws or bolts therein for engaging with said member.

The closure means may further comprise a sealing gasket located between said plate and said member.

In a preferred embodiment the axial length of the aperture is less than 50% of the axial length of the member.

In another preferred embodiment the axial length of the aperture is less than 20% of the axial length of the member.

According to another aspect of the present invention there is provided a coupling for joining at least one first tubular waterproof trunking member of substantially rectangular cross section to at least one second tubular waterproof trunking member of substantially rectangular cross section, the coupling comprising:—
a body adapted to extend within the or each first and second member;
retaining means for retaining said body and the or each said member together; and
at least one extension portion extending around said body and adapted to form a substantially continuous surface between a surface of said coupling and at least one surface of the or each first member and between a surface of said coupling and at least one surface of the or each second member.

By providing a coupling as described above, the advantage is provided that a tubular trunking, of the type described above, can be used, and can provide a waterproof seal between adjacent members. Providing a substantially smooth and continuous surface at the junction between the coupling and the member reduces the number of potential dirt traps.

In a preferred embodiment, edges of said body are shaped so as to provide a substantially smooth transition between an internal surface of the trunking member and a respective internal surface of the body.

In another preferred embodiment said edges are curved.

The retaining means may comprise a hole in said body adapted to align with a hole in a trunking member and adapted to receive a screw or bolt therein.

The hole may further comprise an internal thread.

In a preferred embodiment, said extension portion is provided with at sealing means for sealing between the trunking member and the extension portion.

The sealing means may comprise a gasket attached to said extension portion.

According to a further aspect of the present invention there is provided a coupling means for joining at least one first tubular waterproof trunking member having a rectangular cross section to at least one second tubular waterproof trunking member having a rectangular cross section, the coupling means comprising:—
a body adapted to extend, within the or each first and second member;
retaining means for retaining said body and the or each said member together; and
sealing means extending around said body and adapted to provide a seal between the or each said first and second member.

By providing a sealing means extending around the body adapted to extend within first and second trunking members, the advantage is provided that a waterproof seal can be provided between adjacent members and the transition from one trunking member to the next can be provided in an almost continuous surface with a minimum number of dirt traps.

In a preferred embodiment edges of said body are shaped so as to provide a smooth transition between an internal surface of the trunking member and a respective internal surface of the body.

By providing such a smooth transition, the advantage is provided that as cables are pushed along a section of trunking and over a transition to a next section of trunking the coupling means provides little obstacle to that cable as it passes through.

In another preferred embodiment said edges are curved.

According to another aspect of the present invention there is provided a coupling for joining at least one first tubular waterproof trunking member of substantially rectangular cross section to at least one second tubular waterproof trunking member of substantially rectangular cross section, the coupling means comprising:—
a tubular body, adapted to extend at least partially over the or each first member and at least partially over the or each second member;
retaining means for retaining said body and the or each said member together; and
sealing means for sealing a junction between the first and second members.

By providing a tubular coupling extending partially over the two trunking members being joined together, the advantage is provided that the junction between the first and second trunking members is completely covered, and completely sealed and a relatively smooth external surface having few dirt traps can be provided. The above coupling also has the advantage that the internal surface of the transition between the first and second trunking members is smooth thereby allowing free motion of the cables along the trunking members.

In a preferred embodiment at least one edge of at least one surface of said body is curved.

According to another aspect of the present invention there is provided a coupling for joining at least one first trunking member having a lid thereon to at least one second trunking member having a lid thereon, the coupling comprising:—
a body, adapted to extend at least partially within the or each first and second member;
first retaining means for retaining said body and the or each said member together;
receiving portion adapted to receive all except one edge of surfaces at an end of said member and said respective lid;
clamping means adapted to be located over said edge of said member and lid not received in said receiving portion; and
second retaining means for retaining said clamping means and said retaining portion together.

By providing a coupling as described above the advantage is provided that the clamping means is able to assist in holding the lid of the trunking section in position. In particular, this is advantageous when a waterproof seal is required since the receiving portion can provide a waterproof seal between the adjacent trunking members and the clamping means provides a seal between the adjacent lids. The clamping means also maintains the sealing along the join between the member and the lid to the very end of the member and lid.

In a preferred embodiment the body consists of four surfaces.

By providing the body of the coupling with four surfaces, i.e. including an upper part adjacent the clamping means, the advantage is provided that a better seal between the adjacent lids is provided. However, where three surfaces are provided on said body easier access to the cables is provided once the clamping means has been removed.

According to another aspect of the present invention there is provided a trunking apparatus comprising:—
at least one trunking section substantially as described above; and
at least one coupling substantially as described above.

Preferred embodiments of the present invention will now be described, by way of example only, and not in any limitative sense, with reference to the accompanying drawings in which:—

FIG. 1 is a perspective view of trunking members and a coupling of the prior art;

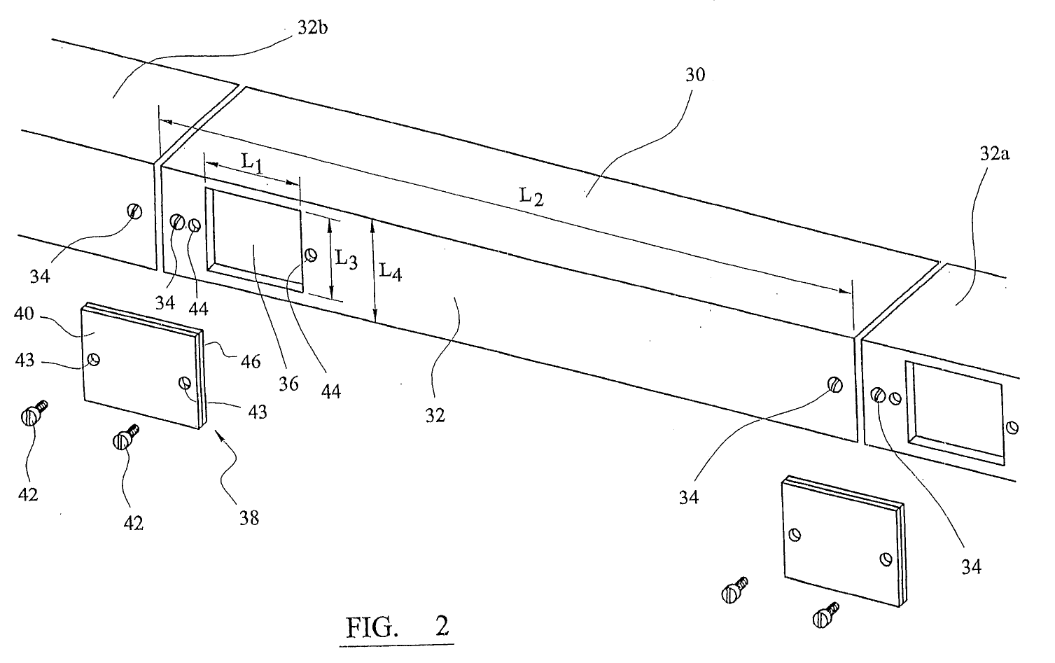

FIG. 2 is a perspective view of trunking sections of a first embodiment of the present invention;

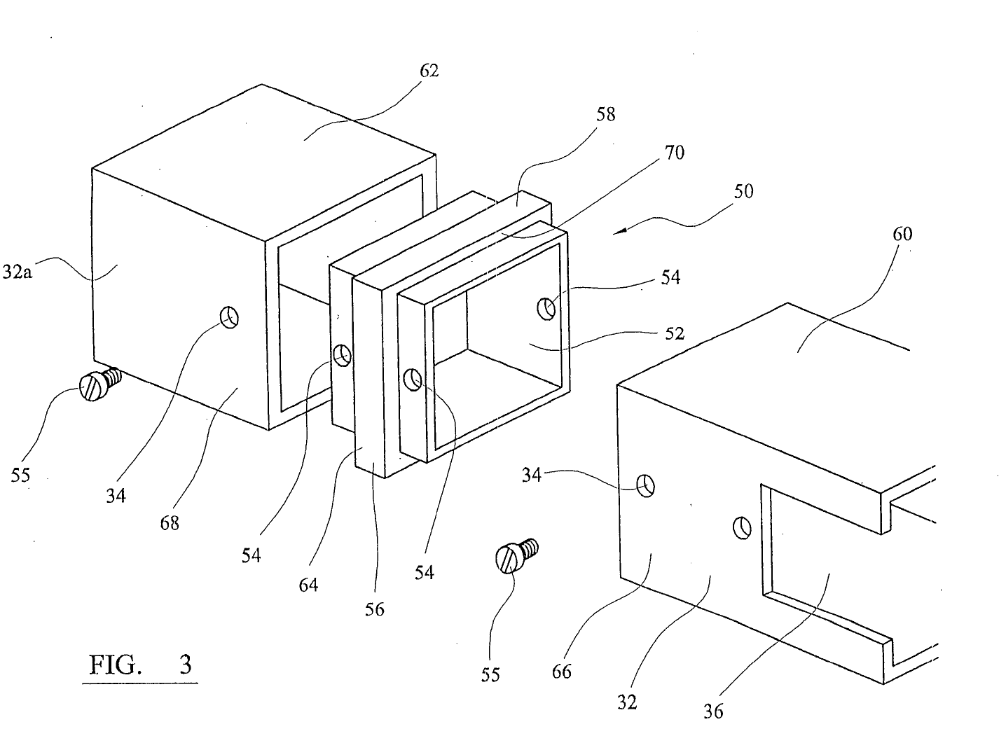

FIG. 3 is a perspective view of a coupling and trunking members of a second embodiment of the present invention;

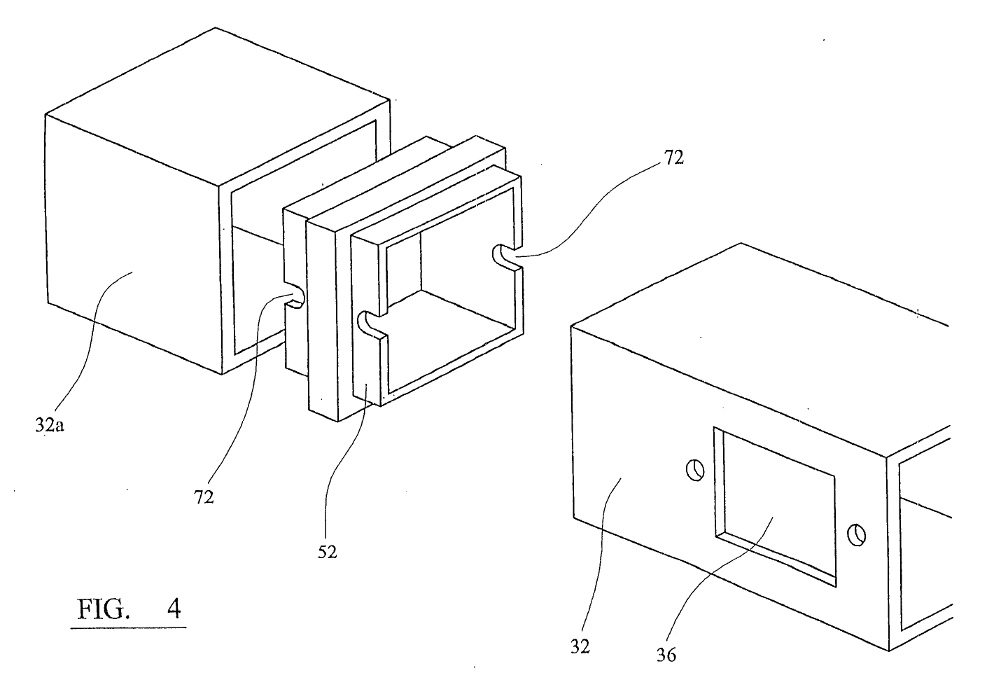

FIG. 4 is a perspective view of a coupling and trunking members of a third embodiment of the present invention;

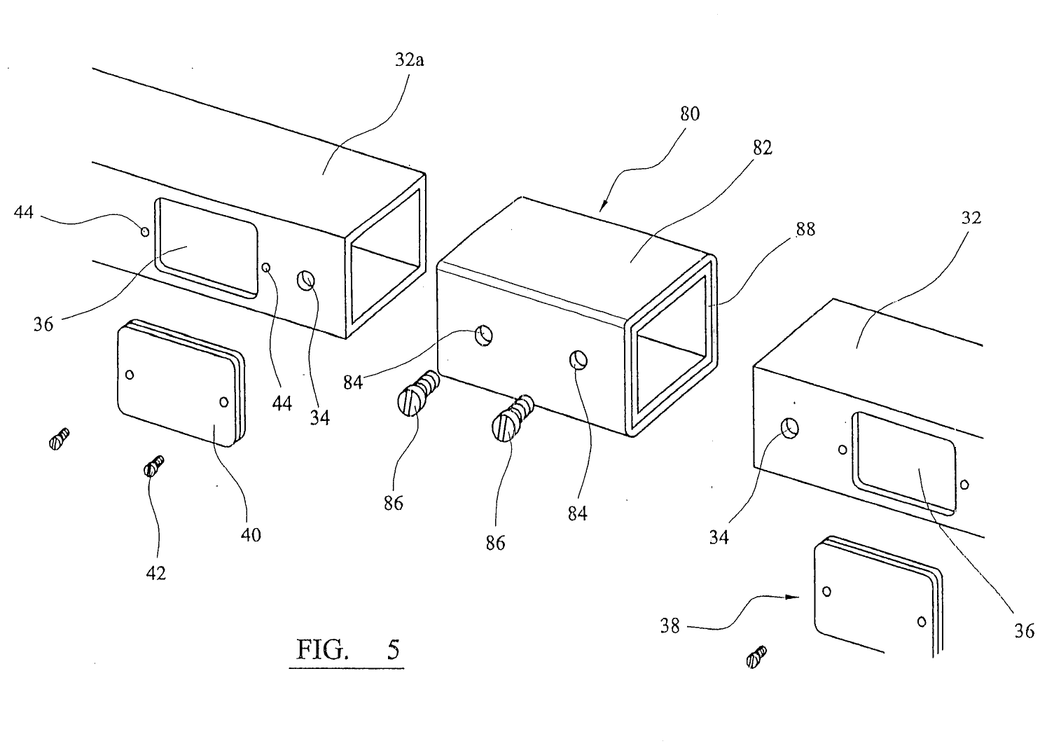

FIG. 5 is a perspective view of a coupling and trunking members of a fourth embodiment of the present invention;

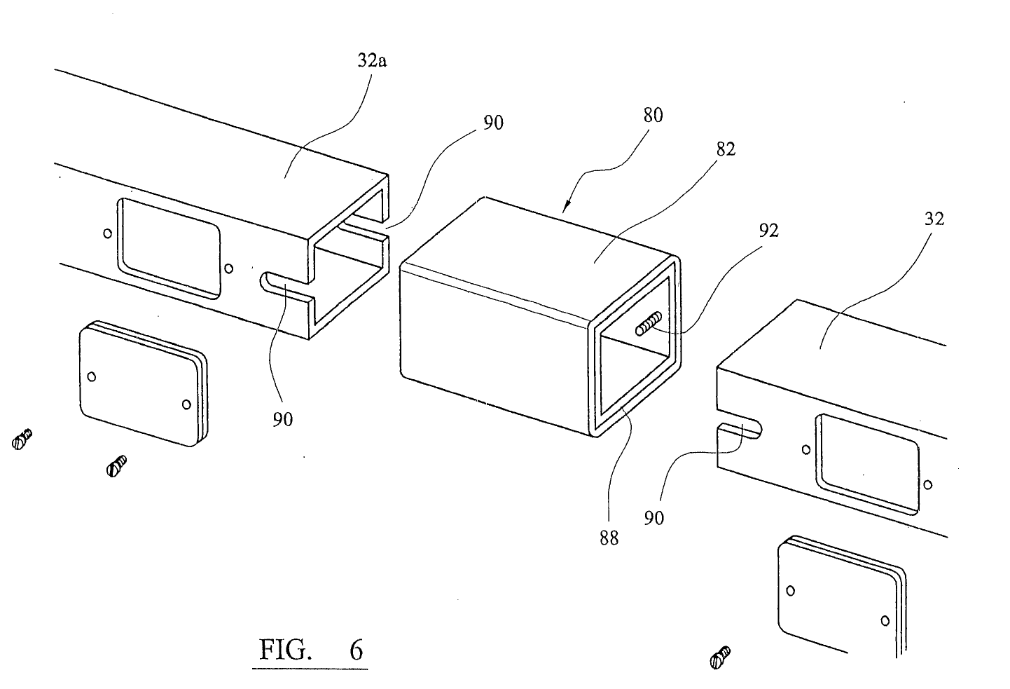

FIG. 6 is a perspective view of a coupling and trunking members of a fifth embodiment of the present invention;

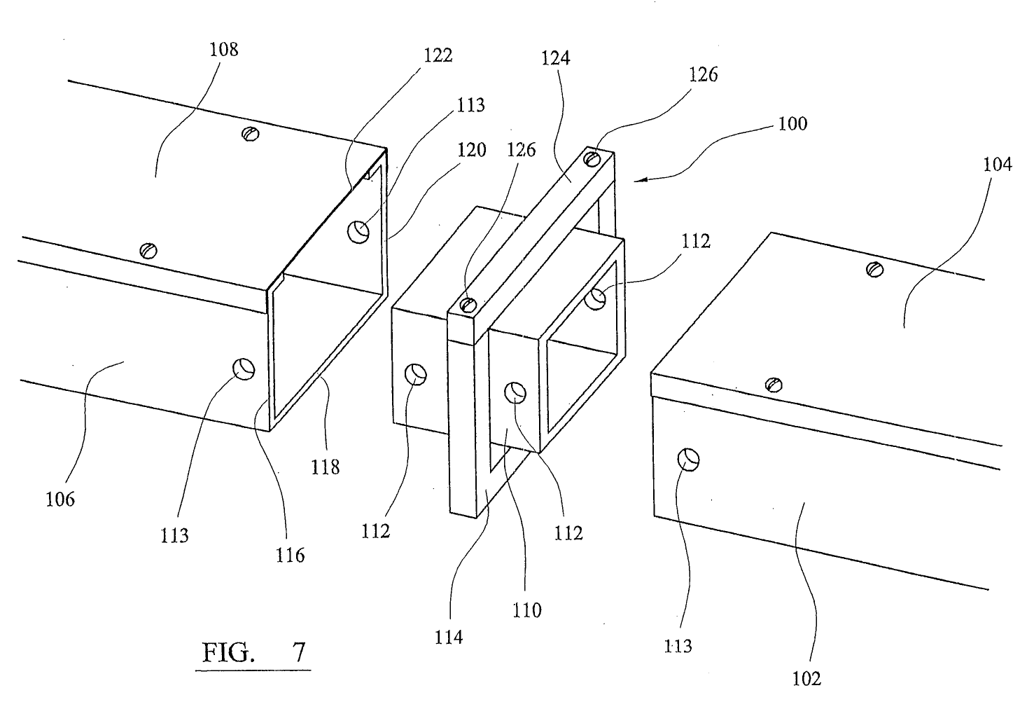

FIG. 7 is a perspective view of a coupling and trunking members of a sixth embodiment of the present invention;

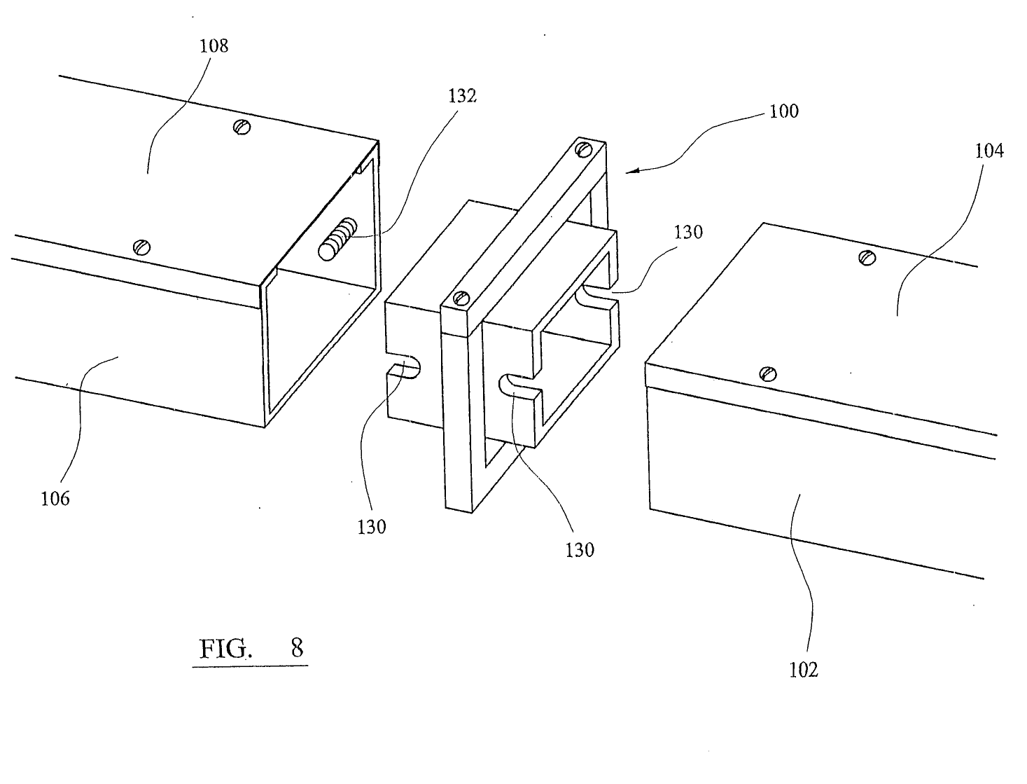

FIG. 8 is a perspective view of a coupling and trunking members of a seventh embodiment of the present invention;

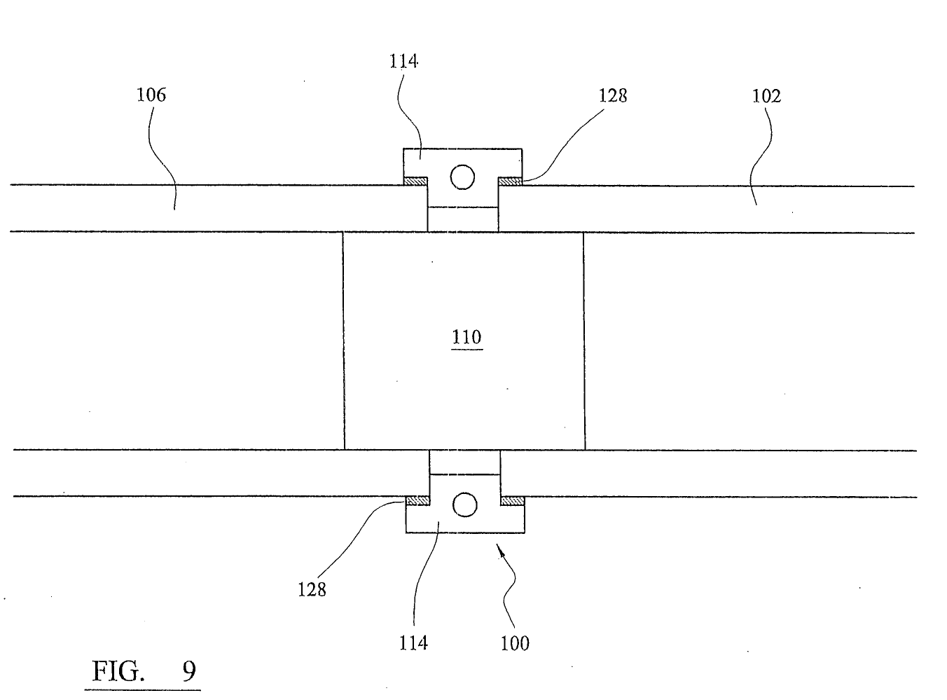

FIG. 9 is a plan view of the coupling and trunking sections of FIGS. 7 or 8; and

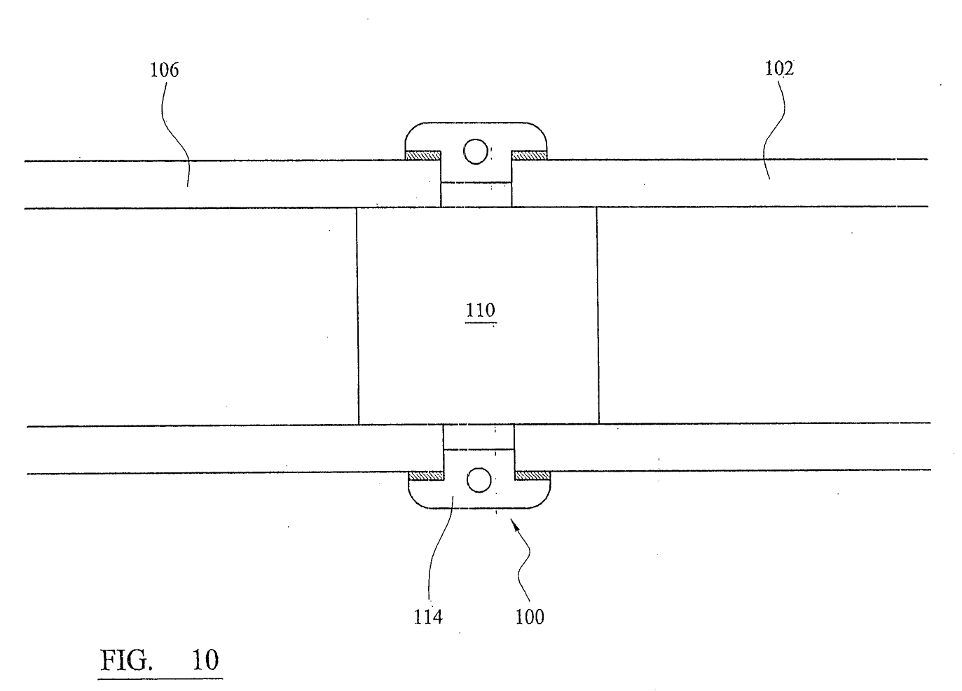

FIG. 10 is a plan view of a coupling and trunking members of an eighth embodiment of the present invention.

Referring to FIG. 2, a section of waterproof trunking 30 has an elongate tubular member 32 of rectangular cross section, two opposing sides of which have holes 34 with screws therein. These holes act as means for attaching member 32 to further members 32a and/or 32b. Member 32 also has an aperture 36 in one side. Aperture 36 has a length L₁ which is substantially less than the length L₂ of member 32, this length being measured axially along member 32. Aperture 36 also has dimension L₃ which is measured perpendicular to L₁ and L₂, and this length is equal to or slightly less than length L₄, the external dimension of member 32 measured in the same direction. Trunking section 30 also has closure means 38 for the or each aperture 36. Closure means 38 has a cover plate 40 which is attached to member 32 by use of screws 42 through holes 43 and into threaded holes 44. Plate 40 is also provided with a neoprene sealing gasket 46.

In use, a trunking member 32 is attached to further trunking members 32a and 32b by use of an internal coupling means (not shown) and held in position the by screws in holes 34. The person installing the trunking, and cabling therein, inserts his hand within aperture 36 and uses this aperture to access the cables inside. When installing a new cable, the cable is passed from one aperture to the next. Once all the cables are installed the closure means 38 are used to cover apertures 36. Plate 40 is placed over aperture 36 and screws 42 are inserted through holes 43 into threaded holes 44. Gasket 46 provides a waterproof seal to the trunking section.

An alternative coupling device might be external of the members 32, 32a and 32b.

Referring to FIG. 3, a coupling 50 for joining a first tubular rectangular waterproof trunking member 32 to a second tubular rectangular waterproof trunking member 32a the coupling having a body 52, which extends within the first and second members 32 and 32a, and retaining means in the form of threaded holes 54.

Holes 54 are adapted to receive screws 55. Coupling 50 also has an extension portion 56 extending around the body 52. Extension portion 56 is formed such that a surface 58 will, in use, form a substantially continuous surface with surface 60 of member 32 and surface 62 of member 32a. Similarly surface 64 of extension portions 56 forms a substantially continuous surface with surface 66 of member 32 and surface 68 of member 32a. Extension portion 56 is also provided with. neoprene gasket 70.

In use, body 52 of coupling 50 is inserted within member 32. Screws 55 are inserted through holes 34 and into threaded holes 54 and tightened so as to provide a strong mechanical joint. Because the coupling 50, member 32 and screw 55 are all formed from stainless steel a good electrical contact is provided between all of these parts and as a result an earth continuity between trunking sections can be maintained. Similarly member 32 is inserted over body 52 such that holes 34 and 54 are aligned and screw 55 is inserted and tightened.

As an alternative, the extension portion 56 maybe entirely formed from a neoprene gasket. This would require that the extension portion be much narrower than that shown so that an almost continuous surface between the surfaces 60 and 66 of member 32, and 62 and 68 of member 32a could be formed. Ideally the edges of and surfaces 60 and 62, and 66 and 68 would be shaped so as to receive the gasket leaving as little neoprene exposed as possible. For example if these edges were given concave surfaces they would provide a suitable seal with a gasket of circular cross-section.

An alternative variation of this coupling is shown in FIG. 4. In this embodiment the retaining means, shown as holes 34 in FIG. 3, are replaced by slots 72 in body 52. Members 32 and 32a are provided with threaded lugs internally of the members, which are not shown on FIG. 4.

In use, body 52 is slotted into members 32 and 32a such that the threaded lugs are located within slots 72. A nut, also not shown, is then tightened over each threaded lug so as to provide a strong mechanical joint with good electrically conducting properties. Access to apply these nuts is gained through apertures 36.

Referring to FIG. 5, a coupling 80 for joining a first tubular rectangular waterproof trunking member to a second tubular rectangular waterproof member has a tubular body 82 is adapted to extend partially over the first and second members 32 and 32a. The coupling 80 also has retaining means, in the form of holes 84, which are adapted to receive screws 86 which in turn engage with threaded holes 34. Coupling 80 also has a neoprene sealing gasket 88.

In use body 82 of coupling 80 is slid over the ends of members 32 and 32a and screws 86 are inserted through holes 84 and tightened in threaded holes 34. As a result a mechanically strong and electrically continuous joint is provided.

An alternative variation of this coupling is shown in FIG. 6. In this embodiment the retaining means, shown as holes 34 in FIG. 5 are replaced with slots 90. The retaining means on body 82 of coupling 80 are four threaded lugs 92, only one of which is shown in FIG. 6.

In use, body 82 of coupling 80 is slid over the ends of members 32 and 32a. Threaded lugs 92 are located within slots 90 and a retaining nut, not shown, is tightened over each lug 92. Neoprene seal 88 provides a waterproof contact between body 82 and members 32 and 32a.

Referring to FIGS. 7 and 9, a coupling 100, for joining a trunking section 102 with respective lid 104 and trunking section 106 with respective lid 108, has a body 110, adapted to be partially received within trunking sections 102 and 106. Coupling 100 also has first retaining means, in the form of threaded holes 112, which receive respective screws, not shown, inserted through holes 113 in trunking sections 102 and 106. Coupling 100 also has receiving portion 114 which extends around three sides of body 110 and is adapted to receive edges of three respective sides of trunking sections 102 and 106 and lids 104 and 108. Normally the inserted edges would be the edges of the trunking sections 102 and 106 and not the edge of lids 104 and 108. For example the edges 116, 118 and 120 of trunking section 106 would be received within receiving portion 114 and edge 122 of lid 108 would not. Coupling 100 also has clamping means 124 and second retaining means 126. Receiving portion 114 is provided with a neoprene gasket 128.

In use coupling 100 is brought into engagement with trunking section 102 and two screws, not shown, are inserted through holes 113 and engage the threads in holes 112. Similarly trunking section 106 is engaged with coupling 100 and two screws are similarly inserted. Cables are then laid in the trunking sections and through the body 110 of coupling 100. This is made easier if the upper most surface of body 110 is not present. Lids 104 and 108 are then attached and screwed to trunking sections 102 and 106 and clamping means 124 is placed on top and fixed in position by second retaining means, screws 126.

Referring to FIG. 10 receiving portion 114 has rounded edges so as to provide a smooth transition between the surfaces of trunking sections 102 and 106 and the surface of receiving portion 114.

An alternative variation of this coupling is shown in FIG. 8. In this embodiment the retaining means, shown as holes 112 in FIG. 7 are replaced with slots 130 which are adapted to receive threaded lugs 132 and are fixed in position using threaded nuts, not shown.

It will be appreciated by persons skilled in the art that the above embodiments have been described by way of example only, and not in any limitative sense, and that various alterations and modifications are possible without departure from the scope of the invention as defined by the appended claims.

1-28. (canceled)

29. A section of waterproof trunking comprising:
at least one elongate tubular member of substantially rectangular cross-section having at least one attaching device for attaching the or each said member to at least one further member and having at least one aperture in at least one respective side of said member for providing access to the interior of said member, wherein the or each said aperture has a length less than the length of the or each said side measured in an axial direction along said tubular member and has a dimension less than the dimension of said side measured transverse to said axial direction; and
at least one respective closure device for the or each said aperture.

30. A section of trunking according to claim 29, wherein at least one said attaching device includes at least one hole in said member adapted to receive a respective screw or bolt for retaining the member in position relative to a further member.

31. A section of trunking according to claim 29, wherein at least one said attaching device is at least one threaded member extending internally from said member and adapted to engage a coupling internally of said member, said coupling having slots therein allowing said threaded members to pass along said slots.

32. A section of trunking according to claim 29, wherein at least one said closure device comprises a plate adapted to cover said aperture.

33. A section of trunking according to claim 32, wherein said plate is provided with a plurality of holes adapted to receive respective screws or bolts therein for engaging with said member.

34. A section of trunking according to either claim 32 at least one said cover device further comprising a sealing gasket located between said plate and said member.

35. A section of trunking according to either claim 33 at least one said cover device further comprising a sealing gasket located between said plate and said member.

36. A section of trunking according to claim 29, wherein the axial length of the aperture is less than 50% of the axial length of the member.

37. A section of trunking according to claim 29, wherein the axial length of the aperture is less than 20% of the axial length of the member.

38. A coupling for joining at least one first tubular waterproof trunking member of substantially rectangular cross section to at least one second tubular waterproof trunking member of substantially rectangular cross section, the coupling comprising:
a body adapted to extend within the or each first and second member;
at least one retaining device for retaining said body and the or each said member together; and
at least one extension portion extending around said body and adapted to form a substantially continuous surface between a surface of said coupling and at least one surface of the or each first member and between a surface of said coupling and at least one surface of the or each second member.

39. A coupling according to claim 38, wherein edges of said body are shaped so as to provide a substantially smooth transition between an internal surface of the trunking member and a respective internal surface of the body.

40. A coupling according to claim 39, wherein said edges are curved.

41. A coupling according to claim 38, wherein at least one said retaining device comprises a hole in said body adapted to align with a hole in a trunking member and adapted to receive a screw or bolt therein.

42. A coupling according to claim 41, said hole further comprising an internal thread.

43. A coupling according to claim 38, wherein said extension portion is provided with at least one sealing device for sealing between the trunking member and the extension portion.

44. A coupling according to claim 43, wherein at least one said sealing device comprises a gasket attached to said extension portion.

45. A coupling device for joining at least one first tubular waterproof trunking member having a rectangular cross section to at least one second tubular waterproof trunking member having a rectangular cross section, the coupling device comprising:—
a body adapted to extend within the or each first and second member;
at least one retaining device for retaining said body and the or each said member together; and
at least one sealing device extending around said body and adapted to provide a seal between the or each said first and second member.

46. A coupling according to claim 45, wherein edges of said body are shaped so as to provide a smooth transition between an internal surface of the trunking member and a respective internal surface of the body.

47. A coupling according to claim 45, wherein said edges are curved.

48. A coupling for joining at least one first tubular waterproof trunking member of substantially rectangular cross section to at least one second tubular waterproof trunking member of substantially rectangular cross section, the coupling means comprising:—
a tubular body, adapted to extend at least partially over the or each first member and at least partially over the or each second member;
at least one retaining device for retaining said body and the or each said member together; and
at least one sealing device for sealing a junction between the first and second members.

49. A coupling according to claim 48, wherein at least one edge of at least one surface of said body is curved.

50. A coupling for joining at least one first trunking member having a lid thereon to at least one second trunking member having a lid thereon, the coupling comprising:—
a body, adapted to extend at least partially within the or each first and second member;
at least one first retaining device for retaining said body and the or each said member together;
receiving portion adapted to receive all except one edge of surfaces at an end of said member and said respective lid;
at least one clamping device adapted to be located over said edge of said member and lid not received in said receiving portion; and
at least one second retaining device for retaining at least one said clamping device and said retaining portion together.

51. A coupling according to claim 50, wherein said body consists of four surfaces.
